(19) United States
(12) Patent Application Publication
(10) Pub. No.: US 2019/0290943 A1
(43) Pub. Date: Sep. 26, 2019

(54) BREATHING HALF MASK

(71) Applicant: Dräger Safety AG & Co. KGaA, Lübeck (DE)

(72) Inventors: Harald HEYER, Klein Wesenberg (DE); Mathias SCHOLZ, Hamburg (DE); Peter CARLSSON, Kinna (SE)

(21) Appl. No.: 16/359,311

(22) Filed: Mar. 20, 2019

(30) Foreign Application Priority Data
Mar. 21, 2018 (DE) 10 2018 002 343.6

(51) Int. Cl. A62B 23/02; A41D 13/11; B01D 39/08; B01D 39/14

(52) U.S. Cl. CPC A62B 23/025; A41D 13/1107; A41D 13/1161; B01D 39/08; B01D 39/14; B01D 2239/069; B01D 2239/045; B01D 2239/0613; B01D 2239/0618; B01D 2239/065; B01D 2239/0435

(57) ABSTRACT

A breathing half mask (1) for protection against particles, aerosols and odors, having two or more mask sections (10). The breathing half mask (1) can be brought from a storage state into a use state by at least one folding process.

### CROSS REFERENCE TO RELATED APPLICATIONS

This application claims the benefit of priority under 35 U.S.C. § 119 of German Application 102018002343.6, filed Mar. 21, 2018, the entire contents of which are incorporated herein by reference.

### FIELD OF THE INVENTION

The present invention pertains to a breathing half mask for protection against particles and aerosols, having two or more mask sections, wherein the breathing half mask can be brought by at least one folding process from a storage state into a use state.

### BACKGROUND OF THE INVENTION

Breathing half masks, especially particle-filtering breathing half masks, are known, in principle. Breathing half masks offer protection, depending on the configuration, against the inhalation of aqueous or oily aerosols and/or particles, for example, fine dust or similar particles. They do not usually offer protection against gases and vapors. Prior-art breathing half masks often consist essentially of a nonwoven and have, furthermore, rubber bands and a pliable nose clip in order to make it possible to provide an especially good adaptation to the face of a user. Prior-art names for breathing half masks also include fine dust masks, dust masks or the English term Filtering Face Piece.

In prior-art breathing half masks, the mask material used is usually selected in respect to the filter property to be provided for the breathing half mask. Further properties of the breathing half mask, especially properties influencing the wearing comfort of the breathing half mask, often cannot be taken into consideration when the mask material is selected. Reduced wearing comfort often cannot be avoided as a result in prior-art breathing half masks. It is known, at any rate, that a thin covering nonwoven can be used for gentle action on the skin.

### SUMMARY OF THE INVENTION

Based on this state of the art, the basic object of the present invention is to at least partially eliminate these drawbacks of breathing half masks. The object of the present invention is therefore to provide a breathing half mask, which can be adapted to requirements in terms of both the filter property to be provided and the highest wearing comfort possible in an as simple and cost-effective manner as possible.

The above object is accomplished by the present invention.

According to a first aspect of the present invention, the object is accomplished by a breathing half mask for protection against particles and aerosols, having two or more mask sections, wherein the breathing half mask can be brought by at least one folding process from a storage state into a use state. A breathing half mask according to the present invention is characterized in that the at least two mask sections have a filter material each, wherein the filter materials of at least two of the at least two mask sections are different from one another.

A breathing half mask according to the present invention is intended for offering protection against particles, aerosols and odors. The breathing half mask can be brought for this purpose into a use state, in which it is configured to cover the nose and the mouth of a user. Fixation or adaptation to the head of a user can be brought about by means of additional elements, for example, a holding strap, especially a rubber band, and/or a nose clip. In addition to the use state already described, the breathing half mask may also be in a storage state, in which the breathing half mask can be stored folded up and consequently in as compact a manner as possible. The breathing mask can preferably be transformed reversibly by at least one folding process, especially a horizontal folding process, between the storage state and the use state.

Provisions are made in a breathing half mask according to the present invention for the breathing half mask to have two or more mask sections. As an essential feature of the present invention, provisions are made in a breathing half mask for these at least two mask sections to have, in turn, a filter material each, wherein these filter materials of at least two of the at least two mask sections differ from one another. In other words, the breathing half mask according to the present invention has at least two mask sections having different filter materials each. Two or more mask sections may also have the same filter material in a breathing half mask according to the present invention with three or more mask sections as long as at least one additional mask section has a different filter material. Due to the use of different filter materials for different mask sections, correspondingly different properties can also be provided for these mask sections. An especially good adaptation of the respective mask sections to requirements that are imposed on these special mask sections can be made possible hereby. For example, mask sections that are essential for the wearing comfort of the breathing half mask, for example, especially mask sections that are in contact with the skin of the user, may thus have a filter material by which the wearing comfort can be increased at least subjectively. Further mask sections may, in turn, have a filter material by which an especially good filter effect can be provided especially with a low breathing resistance at the same time.

On the whole, an especially good wearing comfort can also be provided at the same time for a user of the breathing half mask along with the provision of a desired filter effect with a breathing half mask according to the present invention. This can be provided according to the present invention by the breathing half mask according to the present invention having a plurality of mask sections, wherein the individual mask sections may have different filter materials, especially adapted to the requirements imposed on the particular mask section.

Further, provisions may be made in a breathing half mask according to the present invention for the filter materials of the mask sections to be configured as woven and nonwoven textile filter materials, especially as nonwovens. Woven and nonwoven textile filter materials are used for all mask sections in this especially preferred embodiment of a breathing half mask according to the present invention. In particular, the individual mask sections may also consist of woven and nonwoven textile filter materials. Woven and nonwoven textile filter materials, especially nonwovens, are characterized in that they have, on the one hand, a flexible configuration and, on the other hand, they can nevertheless provide sufficient stability. Woven and nonwoven textile filter materials are thus especially suitable for being able to be used as filter materials for mask sections of a breathing half mask according to the present invention.

Provisions may especially preferably be made, furthermore, in a breathing half mask according to the present invention for two different filter materials to differ from one another in terms of at least one of the following variables:
thickness
weight per unit area
breathing resistance
tactility
rigidity
sealing functionality
permeability to aerosols and particles.

This list is, in particular, incomplete, so that two different filter materials may also differ in terms of additional variables if this is technically meaningful and possible.

A breathing half mask according to the present invention may also be configured such that the filter materials have a layer structure comprising at least one material layer, wherein the layer structures of two different filter materials differ in the number and/or the arrangement and/or the type of the material layers. In particular, an especially high variability of the properties of the filter materials can be made possible by a layer structure of the filter materials. Especially varied possibilities in terms of differences between two different filter materials can also be made possible by such a layer structure. Thus, even the number of the material layers used in the layer structures of the different filter materials may be different. In particular, even a single material layer may already be considered to be a layer structure of a filter material in the sense of the present invention. An arrangement of the individual material layers, for example, in terms of the sequence of the material layers and/or in terms of a relative arrangement of the material layers in relation to one another, may also lead to different filter materials. The type of a material layer is defined in the sense of the present invention especially as the particular layer material used for the material layer or as the internal structure of such a material layer, especially in terms of a thickness, density or similar properties of the material layer.

Moreover, provisions may be made in a breathing half mask according to the present invention for the breathing half mask to have as a mask section a nose section with a nose sealing line, a chin section with a chin sealing line and a mouth section arranged between the nose section and the chin section for defining a breathing space in the use state of the breathing half mask. In this especially preferred embodiment of a breathing half mask according to the present invention, this breathing half mask is thus composed of three mask sections. The nose section and the chin section of the breathing half mask according to the present invention have a nose sealing line and a chin sealing line, respectively, in order to make it possible to provide a sealing during contact with the corresponding parts of the face of a user. These sealing lines may also be improved further, for example, in terms of their sealing effect, by a corresponding coating. A mouth section, which defines essentially a breathing space of the breathing half mask in the use state of the breathing half mask, is arranged between the nose section and the chin section. This breathing space is arranged at least essentially between the mouth or nose of the user and the mouth section of the breathing half mask according to the present invention. A predefined filter property of the breathing half mask, ensured especially by the mouth section, can thus already be provided by such a breathing half mask with three mask sections, along with an increased wearing comfort at the same time, made possible especially by the nose section and by the chin section. For example, the filter materials of the nose section and of the chin section may be selected for this purpose corresponding to an increase in the wearing comfort, and the filter material of the mouth section may be selected especially in terms of the filter effect to be provided.

A breathing half mask according to the present invention can be further improved to the effect that the filter material of the nose section and/or of the chin section has a lower thickness than the filter material of the mouth section. Low thickness of the filter material may be especially decisive in terms of whether the wearing comfort is felt by the user of a breathing half mask according to the present invention as pleasant with the breathing half mask according to the present invention put on. This can be provided in an especially simple manner by using as the filter material of the nose section and/or of the chin section an especially thin filter material, especially a filter material that is thinner than the filter material of the mouth section.

Moreover, a breathing half mask according to the present invention may be further improved to the effect that the filter material of the nose section and/or of the chin section has a lower weight per unit area than the weight per unit area of the mouth section. The weight per unit area of a filter material may also influence the wearing comfort of a breathing half mask according to the present invention. In particular, lighter filter materials with a low weight per unit area may be felt as pleasant by a user of a breathing half mask according to the present invention in contact with the corresponding sections of the face of a user. Provisions can thus be made, in particular, in this embodiment of a breathing half mask according to the present invention for using an especially lightweight filter material in the area of the sealing lines, especially of the nose sealing line and of the chin sealing line. At least a subjective improvement of the wearing comfort can be provided in this manner in case of a breathing half mask according to the present invention.

Provisions may further be made according to an especially preferred improvement of a breathing half mask according to the present invention for the filter material of the nose section and/or of the chin section to have a weight per unit area between about 20 g/m² and about 100 g/m² and/or for the filter material of the mouth section to have a weight per unit area between about 40 g/m² and about 500 g/m². These values have proved, in particular, to be especially preferred for making it possible both to increase the wearing comfort for a user of a breathing half mask according to the present invention and for providing a necessary filter effect by means of the breathing half mask according to the present invention along with a low breathing resistance at the same time.

According to another improvement of a breathing half mask according to the present invention, provisions may further be made for the filter material of the nose section and/or of the chin section to have an equal breathing resistance or a higher breathing resistance than the filter material of the mouth section. It can be facilitated in this manner in an especially preferred manner that a user will breathe through a breathing half mask according to the present invention essentially through the mouth section of the breathing half mask according to the present invention. With the breathing half mask according to the present invention put on, this mouth section is located, as was described above, opposite the mouth and/or the nose of a user, so that an especially good and simple breathing can be made possible for the user. An avoidable impairment of the breathing of the user can be avoided in this manner when a breathing half mask according to the present invention is used.

Further, a breathing half mask according to the present invention may be further improved to the effect that the nose section and the chin section have the same or at least essentially the same filter material. It can be made possible in this manner, in particular, that both the nose sealing line and chin sealing line are formed with the same filter material, as a result of which it is possible to provide, in particular, an overall equal wearing comfort and an equal wearing feeling for the user. By using the same or essentially the same filter material, it is also possible to increase the use of this filter material in the manufacture of a breathing half mask according to the present invention. It is possible to reduce the manufacturing costs in this manner.

Moreover, provisions may be made in case of a breathing half mask according to the present invention for the at least two mask sections to have each at least one connection section, wherein adjacent mask sections are connected at their connection sections. In this especially preferred embodiment of a breathing half mask according to the present invention, this breathing half mask can be configured and provided in an especially simple manner. In this embodiment, such a breathing half mask comprises essentially at least two mask sections, and it also comprises in the sense of the present invention at least essentially additional elements, for example, a holding strap, an additional coating at sealing lines and/or a nose clip or additional supporting elements. To provide a breathing half mask according to the present invention, the at least two mask sections may be arranged, for example, next to one another and be subsequently connected at their connection sections.

A breathing half mask according to the present invention may especially preferably be improved further to the effect that two respective connected mask sections are welded and/or bonded and/or sewn to one another at their connection sections. Welding and/or bonding and/or sewing represent especially simple and especially reliable types of connection for connecting two mask sections to one another. In particular, welding proved to be especially simple and reliable and especially able to be integrated in an automated manufacturing process.

A breathing half mask according to the present invention may also be further improved to the effect that the connection sections of two mask sections, which sections are connected to one another, form a folding area for the at least one folding process. In other words, the borders between the mask sections form at the same time the folding area, which is used for transforming a breathing half mask according to the present invention from its storage state into its use state and/or from its use state into its storage state. Thus, the folding areas needed for the folding process are not arranged in the middle in the mask sections but at the edges thereof in this especially preferred embodiment. A stress on the material of the mask sections due to such folding areas in the interior of the mask sections can be avoided hereby. On the whole, a breathing half mask with improved filter properties can be made possible in this manner.

Provisions may further also be made in a breathing half mask according to the present invention for at least one filter material, especially the filter material of the mouth section, to have a mechanical and/or electrostatic and/or triboelectric filter material. Such mechanical and/or electrostatic and/or triboelectric filter materials are especially preferred for making it possible to provide predefined filter properties or filter properties to be achieved in a breathing half mask according to the present invention. Particles, aerosols and odors can be reliably removed by filter materials configured in this manner from the breathing air of a user with the use of a breathing half mask according to the present invention.

According to a second aspect of the present invention, the object is accomplished by a breathing half mask for protection against particles, aerosols and odors, having two or more mask sections, wherein the breathing half mask can be brought by at least one folding process from a storage state into a use state. The at least two mask sections of the breathing half mask, especially a mouth section of the breathing half mask, advantageously have a mechanical and/or electrostatic and/or triboelectric and/or odor-absorbing filter material. Predefined filter properties or filter properties that are to be achieved can be achieved in a breathing half mask according to the present invention by such mechanical and/or electrostatic and/or triboelectric filter materials and/or by an odor-absorbing filter material. Particles and aerosols and possibly odors can be reliably removed by filter materials having such a configuration from the breathing air of a user.

The present invention will be described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a sectional view of a breathing half mask according to the present invention during its use;

FIG. 2 is a sectional view of a breathing half mask according to the present invention;

FIG. 3 is a view of a breathing half mask according to the present invention during its manufacture;

FIG. 4 is a side view of the breathing half mask in a storage state; and

FIG. 5 is a side view of the breathing half mask in a storage state.

### DESCRIPTION OF THE PREFERRED EMBODIMENTS

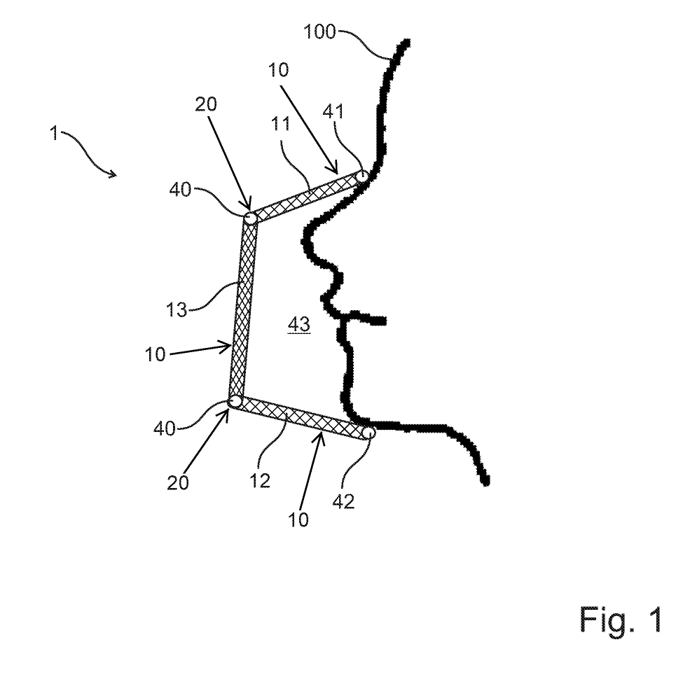

Referring to the drawings, FIG. 1 shows a breathing half mask 1 according to the present invention in its use state during use by a user 100. The breathing half mask 1 and the user 100 are shown in a lateral sectional view. The breathing half mask 1 according to the present invention has especially three mask sections 10. The mask sections 10 are especially a nose section 11, a chin section 12 as well as a mouth section 13. Connection sections 20 of the individual mask sections 10 make it possible to connect two respective adjacent mask sections 10, especially the nose section 11 and the mouth section 13, as well as the mouth section 13 and the chin section 12. The connection sections 20 represent at the same time the folding areas 40, at which the breathing half mask 1 according to the present invention can be brought by a folding process from a storage state into a use state. Further, especially a breathing space 43, which is located essentially between a mouth and a nose of the user 100 and the mouth section 13, is defined by the mouth section 13. The nose section 11 further has a nose sealing line 41 and, analogously to the chin section 12, a chin sealing line 42, which are intended for being in contact with a corresponding face section of the user 100 and which ensure sealing of the breathing half mask 1 according to the present invention against the face of the user 100. The different shadings of the mask sections 10 on the shown breathing half mask 1 according to the present invention already suggest that provisions are made as an essential feature of the present invention for the different mask sections 10 of the breathing half mask 1 according to the present invention to be able to have different filter materials 30 (not shown). It can be made possible in this manner that the different mask sections 10 can also provide different properties, made possible and influenced by the respective filter material 30. For example, the nose section 11 as well as the chin section 12, which may also have, as shown, the same filter material 30, have a filter material 30, which provides for an especially high wearing comfort for a user 100 of a breathing half mask 1 according to the present invention. The filter material 30 of the mouth section 13 may, by contrast, be selected, for example, with respect to an especially low breathing resistance, and the mouth section 13 preferably also provides at least essentially the filter functionality of the breathing half mask 1 according to the present invention. On the whole, both a required filter functionality and a high wearing comfort can be provided by a breathing half mask 1 according to the present invention.

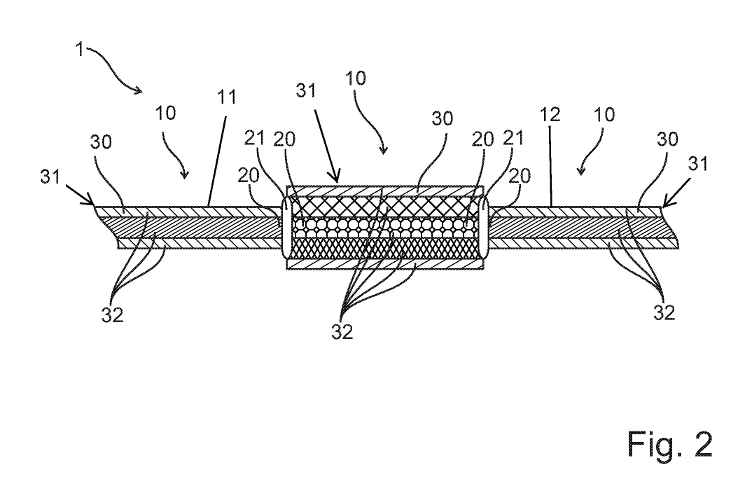

FIG. 2 shows a breathing half mask 1 according to the present invention in a sectional view, wherein especially the different filter materials 30 of the individual mask sections 10 of the breathing half mask 1 according to the present invention are shown. The filter materials 30 of the nose section 11 as well as of the chin section 12 are, in turn, selected as the same material here. It is clearly seen, furthermore, that the individual filter materials 30 have a layer structure 31, where the layer structures 31 differ, for example, in the number of the material layers 32 as well in the use of the types of material layers 32. In particular, the mouth section 13 may have, for example, a layer structure 31 that is configured such that the entire filter material 30 of the mouth section 13 is thicker than the filter materials 30 of the nose section 11 as well as of the chin section 12. Further, it is seen that the connection sections 20 between the nose section 11 and the mouth section 13 as well as between the mouth section 13 and the chin section 12 are reliably connected to one another by a welded connection 21. Such welded connections 21 represent especially reliable connections between the individual mask sections 10, for example, especially when textile filter materials 30 are used as the filter material 30. Further, filter materials 30 having different densities may also be used for the individual mask sections 10, in which case, for example, the filter materials 30 of the nose section 11 as well as of the chin section 12 have a weight per unit area between about 20 g/m² and about 100 g/m² and the filter material 30 of the mouth section 13 has a weight per unit area between about 40 g/m² and about 500 g/m². It can also be made possible in this manner, in particular, that the breathing resistances are different between the individual mask sections 10, the mouth section 13 preferably having the lowest breathing resistance of all mask sections 10 due to the filter material 30 used. An especially unhindered breathing of a user 100 (not shown) can be made possible in this manner by the breathing half mask 1 according to the present invention. To provide the filter property, the filter materials 30, especially the filter material 30 of the mouth section 13, may be configured as a mechanical and/or electrostatic and/or triboelectric filter material 30.

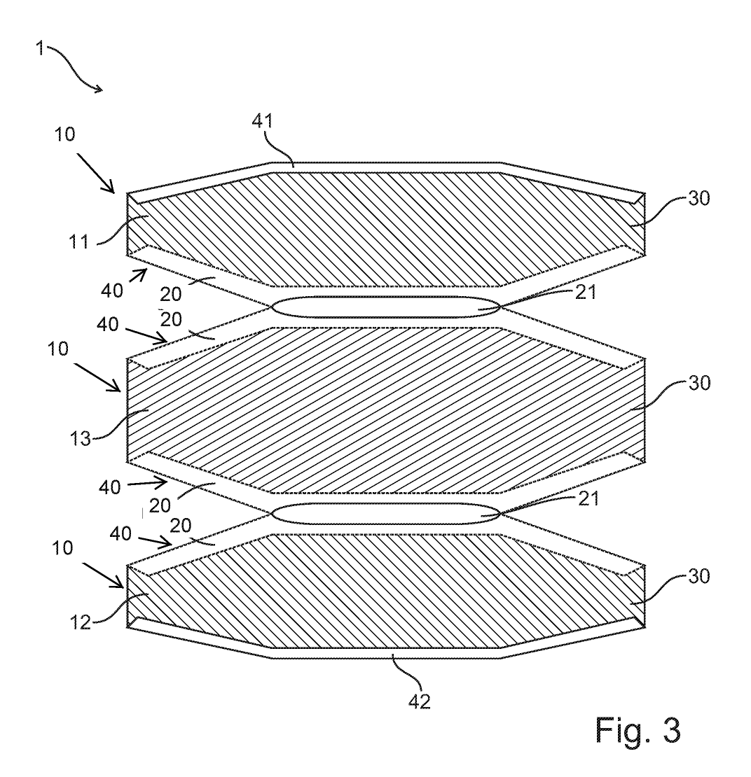

Further, FIG. 3 shows a breathing half mask 1 according to the present invention during the manufacture of the breathing half mask 1 according to the present invention. The individual mask sections 10, especially a nose section 11, a mouth section 13 as well as a chin section 12, are arranged next to one another. Mutually adjacent mask sections 10 are already connected to one another at least partially by a welded connection 21 at their respective connection sections 20. The other sections of the connection sections 20 can also be connected, especially welded, to one another due to an easy folding up, made possible especially by the connection sections 20 being configured as a folding area 40. The different shadings of the individual mask sections 10 already suggest again that at least the mouth section 13 has a different filter material 30 than the nose section 11 as well as the chin section 12. A respective nose sealing line 41 and a chin sealing line 42 are already shown at the ends of the nose section 11 as well as of the chin section 12, which ends face away from the mouth section 13.

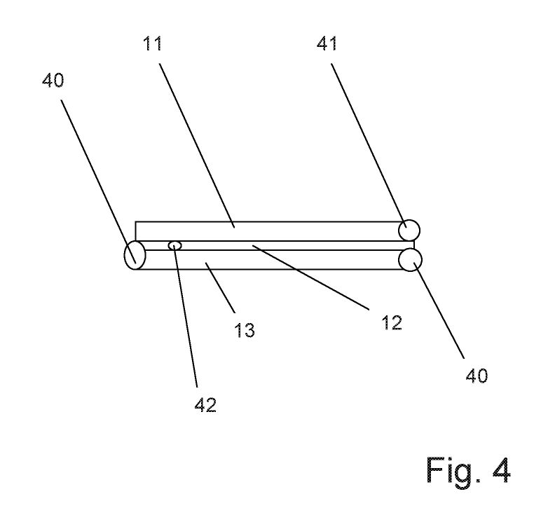

FIG. 4 is a view of the breathing half mask 1 in a storage state wherein the chin section 12 is folded relative to the mouth section 13 and then the nose section 11 is folded relative to chin section 12 and the mouth section 13 such that the chin section 12 is located between the mouth section 13 and the nose section 11. The use state of the breathing half mask 1 is formed by moving the nose section 11 relative to the mouth section 13 and the chin section 12 and then moving the chin section 12 relative to the mouth section 13.

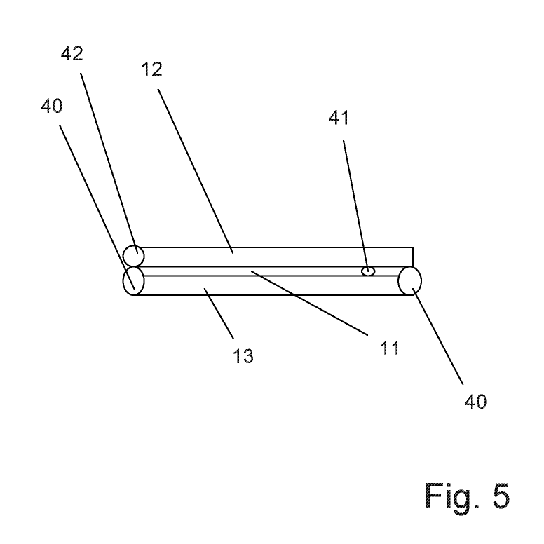

FIG. 5 is a view of the breathing half mask 1 in a folded state wherein the nose section 11 is folded relative to the mouth section 13 and then the chin section 12 is folded relative to nose section 11 and the mouth section 13 such that the nose section 11 is located between the mouth section 13 and the chin section 12. The use state of the breathing half mask 1 is formed by moving the chin section 12 relative to the mouth section 13 and the nose section 11 and then moving the nose section 11 relative to the mouth section 13.

While specific embodiments of the invention have been shown and described in detail to illustrate the application of the principles of the invention, it will be understood that the invention may be embodied otherwise without departing from such principles.

### LIST OF REFERENCE NUMBERS

1 Breathing half mask
10 Mask section
11 Nose section
12 Chin section
13 Mouth section
20 Connection section
21 Welded connection
30 Filter material
31 Layer structure
32 Material layer
40 Folding area
41 Nose sealing line
42 Chin sealing line
43 Breathing space
100 User

What is claimed is:

1. A breathing half mask for protection against particles, aerosols and odors, the breathing half mask comprising:
a breathing half mask structure comprising at least two mask sections, wherein the breathing half mask structure being movable by at least one folding process from a storage state into a use state, each of the at least two mask sections having a filter material, the filter material of at least one of the at least two mask sections being different from the filter material of at least another one of the at least two mask sections.

2. A breathing half mask in accordance with claim 1, wherein the filter material of each of the at least two mask sections is configured as woven and nonwoven textile filter materials.

3. A breathing half mask in accordance with claim 1, wherein the filter material of the at least one of the at least two mask sections and the filter material of the at least another one of the at least two mask sections differ in at least one of thickness, weight per unit area, breathing resistance, tactility, rigidity, sealing functionality and permeability to aerosols and particles.

4. A breathing half mask in accordance with claim 1, wherein the filter material of the at least one of the at least two mask sections and the filter material of the at least another one of the at least two mask sections have a layer structure, the layer structure comprising at least one material layer, the layer structure of the filter material of the at least one of the at least two mask sections and the layer structure of the filter material of the at least another one of the at least two mask sections differ from one another in one or more of a number, an arrangement and a type of material layers.

5. A breathing half mask in accordance with claim 1, wherein the at least two mask sections comprises a nose section with a nose sealing line, a chin section with a chin sealing line and a mouth section arranged between the nose section and the chin section for defining a breathing space in the use state of the breathing half mask structure.

6. A breathing half mask in accordance with claim 5, wherein one or more of the filter material of the nose section and the filter material of the chin section has a thickness less than a thickness of the filter material of the mouth section.

7. A breathing half mask in accordance with claim 5, wherein at least one of the filter material of the nose section and the filter material of the chin section has a lower weight per unit area than the filter material of the mouth section.

8. A breathing half mask in accordance with claim 7, wherein at least one of:
the filter material of the nose section has a weight per unit area between about 20 g/m² and about 100 g/m²;
the filter material of the chin section has a weight per unit area between about 20 g/m² and about 100 g/m²; and
the filter material of the mouth section has a weight per unit area between about 40 g/m² and about 500 g/m².

9. A breathing half mask in accordance with claim 5, wherein at least one of the filter material of the nose section and the filter material of the chin section has one of a same breathing resistance as the filter material of the mouth section and a higher breathing resistance than the filter material of the mouth section.

10. A breathing half mask in accordance with claim 5, wherein the nose section and the chin section have one of a same filter material and at least essentially the same filter material.

11. A breathing half mask in accordance with claim 1, wherein each of the at least two mask sections has at least one connection section to provide at least a plurality of connection sections, wherein adjacent mask sections are connected at the plurality of connection sections.

12. A breathing half mask in accordance with claim 11, wherein each of the at least two mask sections is one or more of welded, bonded and sewn to one another at the plurality of connection sections.

13. A breathing half mask in accordance with claim 11, wherein the plurality of connection sections of two mask sections form a folding area for the at least one folding process.

14. A breathing half mask in accordance with claim 1, wherein at least one of the filter material of at least one of the at least two mask sections and the filter material of at least another one of the at least two mask sections has at least one of a mechanical filter material, an electrostatic filter material and a triboelectric filter material.

15. A breathing half mask in accordance with claim 1, wherein the filter material of each of the at least two mask sections is configured as nonwoven textile filter materials.

16. A breathing half mask in accordance with claim 5, wherein the filter material of the mouth section has at least one of a mechanical filter material, an electrostatic material and a triboelectric filter material.

17. A breathing half mask for protection against particles, aerosols and odors, the breathing half mask comprising:
a breathing half mask structure comprising at least two mask sections, wherein the breathing half mask is movable from a storage state into a use state by at least one folding process, the at least two mask sections having at least one of a mechanical filter material, an electrostatic filter material, a triboelectric filter material and an odor-absorbing filter material.

18. A breathing half mask in accordance with claim 17, wherein the at least two mask sections comprise a mouth section, the mouth section comprising the at least one of the mechanical filter material, the electrostatic filter material, the triboelectric filter material and the odor-absorbing filter material.
